(19) United States
(12) Patent Application Publication
(10) Pub. No.: US 2014/0270336 A1
(43) Pub. Date: Sep. 18, 2014

(54) System and Method for Transaction Authentication

(71) Applicant: MORPHOTRUST USA, INC., Billerica, MA (US)

(72) Inventors: Robert Andrew Eckel, Andover, MA (US); Mohamed Lazzouni, Northborough, MA (US)

(73) Assignee: MORPHOTRUST USA, INC., Billerica, MA (US)

(21) Appl. No.: 14/204,625

(22) Filed: Mar. 11, 2014

Related U.S. Application Data
(60) Provisional application No. 61/800,019, filed on Mar. 15, 2013.

(51) Int. Cl. G06T 1/00

(52) U.S. Cl. CPC G06T 1/0021
USPC 382/100

(57) ABSTRACT

Some implementations provide a method that includes: receiving, from a user on the mobile device, a request for a mobile transaction; inspecting, at the mobile device, a government-issued identification document presented by the user to obtain a digital watermark, the government-issued identification document documenting an identity of a subject; validating the government-issued identification document based on the digital watermark; and in response to validating the government-issued identification document as valid, authenticating the user as authorized to request the mobile transaction being requested.

### CROSS-REFERENCE TO RELATED APPLICATION

This application claims priority under 35 USC §119(e) to U.S. Provisional Patent Application Ser. No. 61/800,019, filed on Mar. 15, 2013, the entire contents of which is hereby incorporated by reference.

### TECHNICAL FIELD

This document generally relates to mobile transactions on mobile devices

### BACKGROUND

Mobile computing devices may engage in mobile transactions such as on-line credit/debit card payment. These mobile transactions may be authenticated to combat on-line fraud and identity theft.

### SUMMARY

In one aspect, some implementations provide a method that includes: receiving, from a user on the mobile device, a request for a mobile transaction; inspecting, at the mobile device, a government-issued identification document presented by the user to obtain a digital watermark, the government-issued identification document viewing or documenting an identity of a subject; validating the government-issued identification document based on the digital watermark (without connection to any external database); and in response to validating the government-issued identification document as valid, authenticating the user as authorized to request the mobile transaction being requested.

In another aspect, some implementations provide a mobile device that includes a processor configured to: receive, from a user on the mobile device, a request for a mobile transaction; inspect a government-issued identification document presented by the user to obtain a digital watermark, the government-issued identification document documenting an identity of a subject; validate the government-issued identification document based on the digital watermark; and; in response to validating the government-issued identification document as valid, authenticate the user as authorized to request the mobile transaction being requested.

Implementations of the above techniques include a method, computer program product and a system. The computer program product is suitably embodied in a non-transitory machine-readable medium and includes instructions executable by one or more processors. The instructions are configured to cause the one or more processors to perform the above described actions.

The system includes one or more processors and instructions embedded in a non-transitory machine-readable medium that are executable by the one or more processors. The instructions, when executed, are configured to cause the one or more processors to perform the above described actions. The default position is not to use any external databases, but the system could be configured to perform a database check if needed.

The details of one or more aspects of the subject matter described in this specification are set forth in the accompanying drawings and the description below. Other features, aspects, and advantages of the subject matter will become apparent from the description, the drawings, and the claims.

### DESCRIPTION OF DRAWINGS

FIG. 1 illustrates an example of a mobile device that authenticates a user requesting a mobile transaction according to some implementations.

FIG. 2 is a flow chart showing an example of a method for authenticating a user requesting the mobile transaction according to some implementations.

FIG. 3 is a flow chart showing an example of a validation method according to some implementations.

FIG. 4A is a flow chart showing an example of an authentication method according to some implementations.

FIG. 4B is a flow chart showing another example of an authentication method according to some implementations.

FIG. 5A illustrates an example of a mobile device authenticating a request by using a government-issued identification document.

FIGS. 5B-D illustrates various examples in which a mobile device validates a government-issued identification document.

Like reference symbols in the various drawings indicate like elements.

### DETAILED DESCRIPTION

Mobile devices, such as smart phones, tablets, laptops, special purpose readers or even home desktops, are increasingly used for mobile transactions. Example mobile transactions may include, for example, payment using a credit/debit card, on-line purchase of merchandise, on-line request for Medicare reimbursement, on-line booking of airline ticket or train ticket. Companies, such as Square and Intuit, have offered payment processing devices that attach to smart phones, such as, for example, an iPhone, a Samsung phone, a HTC phone, etc. Although mobile payments may be processed by these payment processing devices, security concerns surrounding such mobile payments remain. For example, stolen or lost credit/debit cards may be abused rather easily within such context of mobile payment.

Existing mechanisms to authenticate the mobile payments are unable to tie the identity of a person to the mode of payment. To address this problem current solutions employ massive registries of good and fraudulent data. The other problem associated with existing mechanisms is that “local” authentication mechanisms based on barcode and magstripe are known to be highly vulnerable. As these existing mechanisms to authenticate the mobile payments tend to render such mobile payments more cumbersome and less convenient, especially for unsophisticated average users. In contrast, system and methods, such as those disclosed in this application, can authenticate mobile payments based on a physical copy of a government-issued identification document. A government-issued identification document, as discussed in this application, may include a driver license, a passport, a permanent resident card, a social security card, a Medicare card, a Medicaid card, etc. The use of these government-issued identification documents is becoming increasingly common in our society. A valid government-issued identification document may be trusted and relied upon for a variety of applications because the holder of this identification document generally has been authenticated or background-checked by the government during the application process. Authenticating a user requesting a mobile transaction by using a validated government-issued identification document may provide a high probability of authenticity with no significant comprise in speed and convenience. As a result, systems and methods as disclosed herein may be well-suited for use by an average and unsophisticated computer user in authenticating herself/himself during a particular mobile transaction.

FIG. 1 illustrates an example of a mobile device authenticating a user requesting a mobile transaction according to some implementations. Mobile device 101 may include an iPhone, as shown in FIG. 1. Mobile device 101 may also include other smart phones, such as, for example, a Samsung smart phone, a HTC smart phone, an Android smart phone, a Windows smart phone, etc. In addition, mobile device 101 may include a tablet device, for example, an iPad, a Samsung Note device, a Microsoft touch device, etc. Further, mobile device 101 may also include a laptop device, or even a desktop computer at home. Mobile device 101 may receive a request for a mobile transaction, as discussed below.

As illustrated in FIG. 1, the user on mobile device 101 intends to engage in a mobile transaction of making a credit/debit card payment. To this end, payment processing device 102 is mounted on mobile device 101. FIG. 1 shows an Intuit payment processing device for illustration purpose only. Payment processing device 102 may process swipes of credit/debit card 103 by reading the magnetic stripes on credit/debit card 103. Once the credit/debit card has been swiped or read, the information encoded on the magnetic medium of credit/debit card may become available to mobile device 101. The information may include, for example, credit/debit card number, expiration date, holder's name, holder's birth date, holder's residential address, etc. Armed with such information, mobile device 101 is poised to finish off the requested mobile transaction of making the credit/debit card payment. However, the haunting concern of a stolen or lost credit may hinder wider adoption. Without further authentication that the purported user requesting the mobile transaction is the holder of the credit/debit card, a stolen or lost credit/debit card may be easily abused. Examples of spoofing may include reading by unauthorized reader, recording magstripe from an unauthorized source, duplicating the magstripe since it can be easily reproduced. Such abuse increases fees due to fraud and theft. Meanwhile, an overly restrictive credit/debit card use policy may lead to improper denials and render the credit/debit card useless.

According to some implementations, the user may present a government-issued identification document to back up the requested mobile transaction. For example, in FIG. 1, the user proceeds by showing her government-issued identification document 104 at detector 105. As illustrated in FIG. 1, government-issued identification document 104 may include a state-issued driver license. Yet, the identification document 104 is not yet authenticated and the holder of the identification document 104 may not be the rightful owner documented by the identification document 104.

Detector 105 may be a digital camera mounted on mobile device 101 (or an integral part of the mobile device 101). In particular, detector 104 may be any sensor device based on existing technology or technology being developed, including, for example, an infra-red sensor, a photo scanner, a charge-coupled device (CCD) camera, a complementary metal-oxide-semiconductor (CMOS) active pixel sensor, etc.

The user may present government-issued identification document 104 for inspection by placing government-issued identification document 104 immediately to detector 105 for a close-up view. From the close-up view obtained from detector 104, mobile device 101 may obtain, for example, a digital watermark embedded in the government-issued identification document 104. Upon detecting the integrity of the embedded watermark, government-issued identification document 104 may be deemed genuine and thus validated. The watermark in this case is a like a DNA strand which includes a code linking securely and uniquely the identification document, the issuing agency, and the user.

In addition, mobile device 101 may extract payload data from mobile device 101. Payload data may include, for example, name of the holder, birth date of the holder, residential address of the holder, etc. This payload data may provide personally identifiable information of the user requesting the mobile transaction, for example, the payee of the requested credit/debit card payment, as illustrated in FIG. 1. If the payload data is not available from government-issued identification document 104, then some information, such as name of the holder, birth date of the holder, or residential address of the holder, etc. may be obtained by using optical scanner recognition (OCR) techniques based on a scan of the government-issued identification document 104.

In some implementations, for example, the name of the holder of government-issued identification document 104 can be compared with the name of the holder of credit/debit card 103. If the names match, mobile device 101 may proceed with the requested mobile transaction of payment using credit/debit card 103.

The requested mobile transaction may take place using a video camera on mobile device 101. For example, in some implementations, once government-issued identification document 104 has been validated, the store keeper may visually inspect, through a video link provided by the video camera on mobile device 101, the person requesting the mobile transaction who has presented the validated government-issued identification document 104. If the visual inspection confirms that the person requesting the mobile transaction is the person depicted in his/her government-issued identification document, the store keeper may permit the mobile transaction to proceed. For example, the store keeper may honor the mobile payment as a legitimate purchase payment, mark the merchandize as paid, and allow the person to take possession of the merchandize by arranging shipment or authorizing the release.

The person requesting mobile transaction may be different from the person has presented the validated government-issued identification card. For example, in some implementations, a spouse may be the credit/debit card holder while the other spouse may have presented his/her government-issued identification document. As long as the other spouse is an authorized user of the credit/debit card, the mobile transaction may proceed and her/his documents are respectively authenticated. Additionally and if desired, the mobile device 101 may alert the registered owner of the credit/debit card about the mobile transaction. The alert may be sent through email, automatic voicemail, short message service (SMS) message, etc.

The authorization may be implied, for example, based on a pre-existing legal relationship between the person requesting the mobile transaction and the person identified government-issued identification document. The pre-existing legal relationship may be indicated on the government-issued identification document. Information of the pre-existing legal relationship may be encoded in the media, for example, a magnetic strip, a smart card media, etc., of the government-issued identification document. In addition, the pre-existing legal relationship may be documented on a database maintained by a government entity. The legal relationship may include, for example, a spousal relationship, a guardian-dependent relationship, a trust-beneficiary relationship, etc.

The authorization may also be express. For example, the credit/debit card may encode a list of authorized users. If the user authenticated based on the government-issued identification card is on the list of authorized users, then mobile device 101 may submit the mobile transaction. If the user authenticated based on the government-issued identification card is not on the list of authorized users (or the encoded list has not been updated for a period of time, for example, more than three months), then mobile device 101 may submit the mobile transaction that includes information identifying the authenticated user making the request. The credit/debit card company may maintain an up-to-date list of authorized users and may allow the transaction only if the authenticated user is on the up-to-date list of authorized users. Thereafter, mobile device 101 may alert the registered owner of the credit/debit card about the mobile transaction. However, if the authenticated user is not on the up-to-date list of authorized users, the credit/debit card company may deny the mobile transaction and send an alert to the registered owner regarding the denied mobile transaction. The alert may be sent through, for example, an email, an automatic voicemail, or a simple message service (SMS) message, etc.

FIG. 2 is a flow chart showing an example of a method for authenticating a user requesting the mobile transaction according to some implementations. First, a user request for a mobile transaction may be received (202). The mobile transaction may be received at mobile device 101 as illustrated in FIG. 1. However, applicable mobile transactions are not limited to a credit/debit card payment as illustrated in FIG. 1. Mobile transactions may also include, for example, a wire transfer of funds, an on-line purchase request, an on-line request for distribution, an on-line request for reimbursement, an on-line request for account access, etc., as will be discussed in association with FIG. 5A.

Second, mobile device 101 may inspect a government-issued identification document 104 to obtain a digital watermark (204). Government-issued identification document 104 may include a state-issued driver license as illustrated in FIG. 1. Government-issued identification document 104 may not be limited to a state-issued driver license, as will be discussed in association with FIG. 5A. Government-issued identification document may include an embedded digital watermark to identify, for example, the legitimate source of the identification document. The digital watermark may be, for example, embedded in the back-ground image of a state-issued driver license or in the portrait of the document holder. The digital watermark may include digital codes embedded into the media of government-issued identification document. The media may include paper, plastic, magnetic media, etc.

Third, based on the digital watermark, the government-issued identification document may be validated (206). The digital watermark may be generally imperceptible to naked eyes. In fact, the digital watermark may generally appear as noise, for example, added to a background noise. However, the digital watermark can uniquely validate and authenticate the government-issued identification document and carry information about the identity of the holder. Altering a digital watermark may be virtually impossible, and the mere lack of presence of a digital watermark can immediately indicate tampering and likely counterfeiting. Hence, digital watermarks used in a government-issued identification document may provide strong and effective deterrence to counterfeit. In addition, in granting a government-issued identification document, the government generally has conducted a background check of the applicant and verified the applicant's identity according to an established and elaborate protocol. Because of the inherent government authority in granting and issuing the government-issued identification document, possession of a valid government-issued identification document may establish strong proof of the identity of the document holder.

Digital watermarking is secure, covert and machine-readable. To validate the government-issued identification document, the digital watermark may be analyzed according to an example method as illustrated in FIG. 3. Specifically, steganography may analyze the digital watermark and reveal the information identifying the holder. In addition, data contents encoded by the digital watermarks may be encrypted so that the encoded data contents may remain secure, as an additional security mechanism. In some implementations, the digital watermark may be initially analyzed to extract frequency domain information (302). The frequency domain information may include spectrum information manifested by, for example, the digital cosine transforms (DCT) coefficients in a particular spatial frequency range. In contrast to spatial domain information, such frequency domain information may be robust to cropping or translation of the original document. Hence, the frequency domain information may be more tamper-proof and more resilient to artifacts during field use. Likewise, mixed-domain information, i.e., information from both spatial domain and frequency domain may provide similar degree of robustness against tampering and artifacts. However, the implementations disclosed herein are not limited to the use of frequency domain information alone or the use of mixed-domain information. Spatial domain information may be used according to the same scheme as disclosed herein.

The frequency domain information may encode a pattern for validation purposes. The pattern may be chosen by the issuing authority and remain secretive to the outside world. To validate the government-issued identification document, the frequency domain information may be compared with the known pattern (304). In some implementations, the comparison may be performed locally at mobile device 101. In some implementations, mobile device 101 may send the extracted frequency domain information to a central server for the comparison. Details of the different architectures are provided in association with FIG. 5B.

The comparison may determine whether there is a substantial match between the extracted frequency domain information and the known pattern (306). The extracted frequency domain information does not have to perfectly match the known pattern. In some implementations, for example, the frequency domain information may be incomplete due to losses in the scanning process. In some implementations, the degree of match may depend on the context of the application. For example, for applications involving mobile transactions with a financial sum of under $500, a lower degree of match authentication level may be sufficient. While for applications involving mobile transactions regarding, for example, any purchase of controlled substances, a higher degree of match may be adopted. In some implementations, the matching process may depend on jurisdiction. For example, in some states which adopted a less sophisticated digital watermark, a more primitive match procedure may be performed. Even in states that have adopted a more sophisticated digital watermark, legacy identification cards may still use the old and less sophisticated digital watermarking. These legacy identification cards may still be honored by a more primitive matching procedure. In some implementations, ascertaining whether there is a substantial match may further factor in prior dealings between the person requesting the mobile transaction and the holder of the government-issued identification document. For example, if the person requesting the mobile transaction has been paying for the holder of the government-issued identification document frequently in the past, then the degree of match may be lessened to simplify the process. A trusted consumer database can be set up if needed.

If substantial match has been found between the extracted frequency domain information and the pattern, mobile device 101 may authenticate the government-issued identification document (310). Conversely, if substantial match has not been found between the extracted frequency domain information and the pattern, mobile device 101 may reject the validity of the government-issued identification document. In some implementations, the mobile device may alert the holder of the government-issued identification document of the rejection. The mobile device could also ask for another valid form of identification and, an alert may be sent through email, automatic voicemail, short message service (SMS) message, etc.

When government-issued identification document has been validated, mobile device 101 may read information of the holder encoded in the document. The information may include, for example, name, gender, age, birth date, residential address, telephone number, or physical characteristics of the holder, etc. Example physical characteristics may include height, weight, hair color, eye color, etc. Such information may be encoded in a magnetic stripe or barcode. In some implementations, mobile device may simply scan the document and extract such information by, for example, OCR techniques.

Returning to FIG. 2, the information of the holder may be used to authenticate that the user requesting the mobile transaction is the person authorized to request the mobile transaction (208). The authentication may compare the information of the holder with data associated with the person requesting the mobile transaction. The data of the user requesting the mobile transaction may include, for example, the name, age, gender, or residential address of the requester. Such data may be obtained, for example, from the mobile transaction request itself. In the example of credit/debit card payment as illustrated in FIG. 1, the data may be read from credit/debit card 103 by card reader 102.

Example authentication processes according to some implementations are illustrated in FIGS. 4A and 4B. Referring to FIG. 4A, an example authentication method may initiate by comparing the identity of the user requesting the mobile transaction and the identity of the subject issued by the government according to the identification document (402). The identity may include at least one of: a name, an age, a birth date, a residential address, or a sequence number. The sequence number may include, for example, a social security number, a driver license number, a veteran number, a passport number, an alien registration number, etc.

Mobile device 101 may ascertain whether there is a match between the identity of the user making the request for the mobile transaction and the identity of the subject issued by the government as documented by the identification document (404). At no time is the personally identifiable information of the user stored or held for future use. In the context of matching one identity to another identity, the match may be exact when comparing two numeric values while the match may be case insensitive when comparing two character strings (such as names) or alpha-numeric strings (such as addresses). The degree of match may also depend on the underlying mobile transaction. If the underlying mobile transaction involves a financial sum of over $500 or a purchase of any controlled substances, the degree of match may be high. Conversely, if the underlying mobile transaction involves a petite sum (for example, a financial sum of under $50), the degree of match may be lessened.

If mobile device 101 identifies a match between the identity of the user making the request for the mobile transaction and the identity of the subjected issued by the government as documented by identification document, mobile device 101 may determine that the user is authorized to request the mobile transaction (406). However, if mobile device 101 fails to identify a match between the identity of the user making the request for the mobile transaction and the identity of the subjected recorded by the government-issued identification document, mobile device 101 may determine that the user is not authorized to request the mobile transaction (408). If it is a legitimate error the user will be prompted to present another valid proof of ID. As discussed above, in some implementations, depending on the legal relationship between the user making the request for the mobile transaction and the person presenting the government-issued identification document, mobile device may still authorize the requested mobile transaction to proceed, if, for example, the user requesting the mobile transaction has been authorized by the holder of the government-issued identification document.

Referring to FIG. 4B, another example authentication method may initiate by comparing the identity of the subject issued by the government as documented by identification document with a requirement for the mobile transaction (412). In some implementations, the identity of the subject issued by the government may be checked for the age, the residential address, etc. to comply with legal requirements for engaging in the requested mobile transaction. For example, the legal drinking age may be the requirement for the requested mobile transaction of purchasing liquor, alcohol, or wine products. Based on the context, the legal drinking age in the jurisdiction where the mobile transaction is placed and the legal drinking age in the jurisdiction where the on-line vendor is located may be different. Both legal requirements may be included. The legal age for requesting social security distribution may be another example requirement. For example, different jurisdiction may impose varying restrictions on on-line purchase requests and therefore the residential address or residential history may be yet another example requirement.

Mobile device 101 may ascertain whether the identity of the subject issued by the government satisfies the requirement for the mobile transaction (414). In the case of multiple legal requirements, mobile device 101 may ascertain whether all such legal requirements are satisfied.

If the identity of the subject issued by the government as documented by identification document satisfies the requirement for the mobile transaction, mobile device 101 may determine that the user is authorized to request the mobile transaction (406). However, if the identity of the subject issued by the government as documented by the identification document does not satisfy the requirement for the mobile transaction, mobile device 101 may determine that the user is not authorized to request the mobile transaction (408). As discussed above, in some implementations, depending on the legal relationship between the user making the request for the mobile transaction and the person presenting the government-issued identification document, mobile device may still authorize the requested mobile transaction to proceed, if, for example, the user requesting the mobile transaction is the beneficiary of the holder of the government-issued identification document.

FIG. 5A illustrates an example of a mobile device authenticating a request by using a government-issued identification document. Upon receiving a request for a mobile transaction (502), mobile device 101 may expect a credential to back up the request. The credential may come in the form of a government-issued identification card 504. In some implementations, mobile device 101 may prompt the user of mobile device 101 to present his or her government-issued identification card 504. In some implementations, the user of mobile device 101 may present his or her government-issued identification card 504 without being prompted by mobile device 101.

The request for mobile transaction 502 may include a request for a credit/debit card payment, a request for a wire transfer of funds, an on-line purchase request, an on-line request for distribution, an on-line request for reimbursement, an on-line request for account access, etc.

A wire transfer may allow the requester to transfer funds in one account to another account, for example, in a different bank in a different locale or country. The wire transfer request may also include requests to fund an on-line stock or stock option purchase through a checking account, a savings account, etc.

An on-line purchase request may include a purchase request for a special item. The purchase request may be at a point of service when a customer comes in person to collect a controlled item for which the customer needs to be vetted before collecting the controlled items. The special item or controlled item may include, for example, alcohol, liquor, wine, small arms, ammunitions, over-the-counter (OTC) drugs that may contain controlled substances etc. Controlled substances may include any substances that falls under the Controlled Substances Act. Additionally, the special item may also include certain electronics equipment and accessories that may be used for surveillance or eavesdropping.

An on-line request for distribution may include a request for a distribution of social security benefits, a retirement plan distribution, a pension plan distribution etc.

An on-line request for reimbursement may include a request for reimbursement of Medicare benefits, Medicaid benefits, or a state-sponsored health care plan such as, for example, MediCal in the state of California. The on-line request for reimbursement may additionally include a request for private insurance reimbursement for health care expenses, property repair expenses for auto or home, etc.

An on-line request for account access may include a request to change any information in an on-line account, such as, for example, an on-line EZ-pass account, an on-line individual Department of Motor Vehicle (DMV) account, an on-line bank account, an on-line credit/debit card account, etc. The on-line request for account access may also include a request for payment through an intermediary, such as a PayPal account, a BillMeLater account, etc.

government-issued identification card 504 may include a state-issued driver license, a passport issued by the State Department, a permanent resident card issued by the Unites States Citizenship and Naturalization Service (USCIS), a naturalization certificate issued by the USCIS, a social security card issued by the social security service, a Medicare card issued by the Department of Human and Health Services (DHHS), a Medicaid card issued by the DHHS. Government-issued identification document may additionally include a national identification card, as used in countries in Europe, Asia, and Latin America. Government-issued identification document may also include a state-issued Medicare card, such as the Medical card issued by the state of California, etc.

FIGS. 5B-D illustrates various examples in which a mobile device validates a government-issued identification document. Once presented with the government-issued identification document, mobile device 101 may validate the identification card locally on-site, as shown in FIG. 5B. The on-site validation may be based on the digital watermark as discussed above.

Referring to FIG. 5C, in some implementations, mobile device 101 may transmit information encoding the digital watermark to commercial central server 506. The information encoding the digital watermark may be transmitted along with a validation request 501 to commercial central server 506. Commercial central server 506 may house a database for validating digital watermark. The validation may be based a comparison of frequency-domain information or mixed-domain information, as outlined above. Frequency domain information may be more robust than spatial domain information for being more tamper-proof and resilient to errors (for example, due to cropping or zooming). However, the implementations disclosed herein are not limited to frequency-domain information or mixed-domain information and can be applied to spatial-domain information. When commercial central server 506 finishes the validation, commercial central server 506 may transmit validation request 512 back to mobile device 101. Thereafter, mobile device 101 may act accordingly based on the contents of validation result 512, as discussed above.

Referring to FIG. 5D, in some implementations, mobile device 101 may transmit information encoding the digital watermark to government central server 508. The information encoding the digital watermark may be transmitted along with a validation request 501 to government central server 508. Digital watermarking may also work across jurisdictions, from federal to state or from state to state. As the issuer of government-issued identification document 504, government central server 508 may house a database of raw information for validating digital watermark. Government central server 508 may be administered by the issuing agency directly, or through a proxy, including, for example, a third-party independent contractor. In some implementations, commercial central server may transmit additional validation request to government central server 508 for final resolution of a validation request originally sent from mobile device 101.

In some implementations, the paradigm of authentication can be used without a tie to a database. In some implementations, the authentication can also be used in relation to a database if so desired. Authentication solutions to address on-line fraud or identity theft may incorporate sophisticated software mechanisms. Such authentication solutions may be cumbersome and less user-friendly, especially an average and unsophisticated user. In contrast, government-issued identification documents are becoming more acceptable in that they are used by people from all walks of life. In addition, government-issued identification document carries the authentication digital watermark issued by the government and tend to be self-authenticating. Moreover, before a government-issued identification document is issued, an elaborate verification process has been performed by the government to confirm that the applicant is who he or she purports to be and that the information provided by the applicant is accurate and complete, as of the application date. As disclosed herein, these features of a government-issued identification document may be incorporated by a mobile device to authenticate that a user requesting a mobile transaction is authorized to request the mobile transaction. The resulting authentication method addresses on-line fraud and identity theft issues with no significant compromise in convenience and ease of use. The resulting authentication method may be readily implemented on a variety of mobile devices, such as, for example, a smart phone, a tablet device, a laptop device, or even a home desktop computer.

Various implementations of systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The use of the digital watermark is stateless. During an implemented method, the personally identifiable information of the user stored or held is not stored for future use. These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The elements of a computer may include a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the systems and techniques described here can be implemented on a computer having a display device (e.g., a CRT (cathode ray tube), LCD (liquid crystal display) monitor, LED (light-emitting diode) or OLED (organic light-emitting diode) monitors) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the invention. For example, much of this document has been described with respect to messaging and mapping applications, but other forms of graphical applications may also be addressed, such as interactive program guides, web page navigation and zooming, and other such applications.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A method, comprising:
receiving, from a user on the mobile device, a request for a mobile transaction;
inspecting, at the mobile device, a government-issued identification document presented by the user to obtain a digital watermark, the government-issued identification document documenting an identity of a subject;
validating the government-issued identification document based on the digital watermark;
and in response to validating the government-issued identification document as valid, authenticating the user as authorized to request the mobile transaction being requested.

2. The method of claim 1, further comprising:
subsequent to authenticating the user as authorized to request the mobile transaction, proceeding with the mobile transaction request by submitting the mobile transaction request as an authorized request.

3. The method of claim 1, wherein the mobile transaction comprises one of: a credit/debit card payment, an on-line purchase, an on-line reimbursement, or an on-line distribution, or an on-line account access.

4. The method of claim 1, wherein the request for the mobile transaction comprises an identity of the user requesting the mobile transaction.

5. The method of claim 4, wherein the identity of the user comprises at least one of: a name, an age, a birth date, a residential address, a residence history, or an identification number.

6. The method of claim 5, wherein the identification number comprises one of: a social security number, a Medicare serial number, a Medicaid serial number, an alien registration number, or a tax identification number.

7. The method of claim 4, wherein authenticating comprises: determining that the user has sufficient credentials to proceed with the requested mobile transaction.

8. The method of claim 7, wherein the user has sufficient credentials when the identity of the user requesting the mobile transaction matches the identity of the subject documented by the government-issued identification document.

9. The method of claim 7, wherein the user has sufficient credentials when the identity of the subject documented by the government-issued identification document satisfies a requirement for the mobile transaction.

10. The method of claim 9, wherein the requirement for the mobile transaction comprises at least one of: an age, a residential address, a residence history, a social security credit, a Medicare credit, or a Medicaid credit.

11. The method of claim 1, wherein the government-issued identification document comprises one of: a driver license, a passport, a social security card, a permanent resident card, a Medicare card, a Medicaid card, or state-issued Medicare card.

12. The method of claim 1, wherein the digital watermark comprises at least one of: frequency domain information identifiable by steganography, or spatial domain information identifiable by stenography.

13. The method of claim 12, wherein validating the government-issued identification document comprises:
extracting the frequency domain information;
comparing the frequency domain information to a known pattern that is kept as a secret; and
in response to the frequency domain information substantially matching the known pattern, determining the government-issued identification document as valid.

14. The method of claim 1, wherein the mobile device comprises: a mobile phone, a smartphone, a tablet, a laptop, or a wireless computer.

15. A mobile device, comprising a processor configured to:
receive, from a user on the mobile device, a request for a mobile transaction;
inspect a government-issued identification document presented by the user to obtain a digital watermark, the government-issued identification document documenting an identity of a subject;
validate the government-issued identification document based on the digital watermark; and
in response to validating the government-issued identification document as valid, authenticate the user as authorized to request the mobile transaction being requested.

16. The mobile device of claim 15, wherein the processor is further configured to:
subsequent to authenticating the user as authorized to request the mobile transaction, proceeding with the mobile transaction request by submitting the mobile transaction request as an authorized request.

17. The mobile device of claim 15, wherein the mobile transaction comprises one of: a credit/debit card payment, an on-line purchase, an on-line reimbursement, or an on-line distribution, or an on-line account access.

18. The mobile device of claim 15, wherein the request for the mobile transaction comprises an identity of the user requesting the mobile transaction.

19. The mobile device of claim 18, wherein the identity of the user comprises at least one of: a name, an age, a birth date, a residential address, a residence history, or an identification number.

20. The mobile device of claim 19, wherein the identification number comprises one of: a social security number, a Medicare serial number, a Medicaid serial number, an alien registration number, or a tax identification number.

21. The mobile device of claim 18, wherein authenticating comprises: determining that the user has sufficient credentials to proceed with the requested mobile transaction.

22. The mobile device of claim 21, wherein the user has sufficient credentials when the identity of the user requesting the mobile transaction matches the identity of the subject documented by the government-issued identification document.

23. The mobile device of claim 18, wherein the user has sufficient credentials when the identity of the subject documented by the government-issued identification document satisfies a requirement for the mobile transaction.

24. The mobile device of claim 23, wherein the requirement for the mobile transaction comprises at least one of: an age, a residential address, a residence history, a social security credit, a Medicare credit, or a Medicaid credit.

25. The mobile device of claim 15, wherein the government-issued identification document comprises one of: a driver license, a passport, a social security card, a permanent resident card, a Medicare card, a Medicaid card, or state-issued Medicare card.

26. The mobile device of claim 15, wherein the digital watermark comprises at least one of:
frequency domain information identifiable by steganography, or spatial domain information identifiable by stenography.

27. The mobile device of claim 26, wherein validating the government-issued identification document comprises:
extracting the frequency domain information;
comparing the frequency domain information to a known pattern that is kept as a secret; and
in response to the frequency domain information substantially matching the known pattern, determining the government-issued identification document as valid.

28. The mobile device of claim 18, wherein the mobile device comprises: a mobile phone, a smartphone, a tablet, a laptop, or a wireless computer.

29. A computer-readable medium comprising software instructions that when executed by one or more processors, cause the one or more processors to:
receive, from a user on the mobile device, a request for a mobile transaction;
inspect a government-issued identification document presented by the user to obtain a digital watermark, the government-issued identification document documenting an identity of a subject;
validate the government-issued identification document based on the digital watermark; and
in response to validating the government-issued identification document as valid, authenticate the user as authorized to request the mobile transaction being requested.
